(19) United States
(12) Patent Application Publication
(10) Pub. No.: US 2026/0249700 A1
(43) Pub. Date: Aug. 27, 2026

(54) Protective Device for an Electrical Energy Store and Arrangement

(71) Applicant: Bayerische Motoren Werke Aktiengesellschaft, Muenchen (DE)

(72) Inventors: Daniel HEIM, Neufahrn (DE); Julian HEIM, Eichenau (DE)

(21) Appl. No.: 19/489,671

(22) PCT Filed: Jun. 5, 2024
(86) PCT No.: PCT/DE2024/100505

§ 371 Date: Dec. 3, 2025

(30) Foreign Application Priority Data
Jun. 29, 2023 (DE) 10 2023 117 122.4

(51) Int. Cl. B60L 3/00; B60K 1/04; H01M 50/242; H01M 50/249

(52) U.S. Cl. CPC B60L 3/0007; B60K 1/04; H01M 50/242; H01M 50/249; B60K 2001/0438; B60Y 2306/01

(57) ABSTRACT

A protective device for an electrical energy store for an electrically drivable motor vehicle has at least one fastening region, via which the protective device is to be held on an underside, pointing downwards in the vertical direction of the motor vehicle, of a storage housing, formed separately from the protective device, of the electrical energy store. The protective device has an organosheet with at least one ribbed structure.

### BACKGROUND AND SUMMARY

The invention relates to a protective device for an electrical energy store for an electrically drivable motor vehicle. Furthermore, the invention relates to an arrangement of a protective device on a storage housing of an electrical energy store for an electrically drivable motor vehicle.

DE 10 2017 128 529 B4 discloses a motor vehicle battery, specifically a traction battery of a motor vehicle, having a battery housing which has a housing interior that in regions is delimited by a housing frame and a housing base. The motor vehicle battery has a plurality of battery modules disposed in the housing interior.

It is an object of the invention to achieve a protective device for an electrical energy store for an electrically drivable motor vehicle, and an arrangement of a protective device on a storage housing of an electrical battery store for an electrically drivable motor vehicle, in such a way that safety in terms of damage to the electrical energy store can in particular be enhanced and the electrical energy store can be repaired with particularly little effort.

This object is achieved by a protective device for an electrical energy store for an electrically drivable motor vehicle and by an arrangement of a protective device on a storage housing of an electrical energy store for an electrically drivable motor vehicle having the features of the independent claims. Advantageous design embodiments of the invention are the subject matter of the dependent patent claims and of the description.

A first aspect of the invention relates to a protective device, in particular a protective board, for an electrical energy store for an electrically drivable motor vehicle. The motor vehicle, in particular in its completely assembled state, preferably has the electrical energy store, and in particular the protective device. The protective device can be part of the electrical energy store, or the protective device can be formed separately from the electrical energy store.

The motor vehicle is preferably designed as a passenger motor vehicle. An electrically drivable motor vehicle can be understood to be in particular a battery-powered electric vehicle or a hybrid vehicle. In other words, the motor vehicle has at least one electric machine by means of which the motor vehicle is able to be driven, in particular purely electrically.

The electrical energy store can be understood to be in particular a battery, or a rechargeable battery, respectively. The electrical energy store is preferably designed as an electrical traction store, in particular as a traction battery, of the motor vehicle. This means that for driving the motor vehicle, the electric machine of the motor vehicle is able to be supplied, or is supplied, with energy stored, or chemically bound, in the electrical energy store. The electrical energy store can in particular be referred to as a battery storage system.

In order to be able to implement a particularly high electrical output for electrically, in particular purely electrically, driving the motor vehicle, the electrical energy store can have an electrical voltage, in particular an electrical operating or nominal voltage, which is preferably more than 50 V, in particular more than 60 V, and preferably is several 100 V. Accordingly, the electrical energy store is preferably designed as a high-voltage component, the electrical energy store consequently being able to be referred to as a high-voltage store.

The electrical energy store has at least one storage housing. The electrical energy store preferably has at least one receptacle space which is at least partially, in particular largely or completely, delimited or formed, in particular directly, by the storage housing. Preferably, a plurality of storage elements, in particular storage cells, are able to be disposed, or are disposed, in the receptacle space. The storage cells are preferably battery cells.

Preferably, the electrical energy store, in particular in its installed position in the motor vehicle, is disposed in the vehicle vertical direction below a floor element, in particular a main floor, of a body of the motor vehicle. For example, the electrical energy store is to be held, or is held, in particular at least indirectly or directly, on the floor element by way of the storage housing and/or by way of a support structure of the electrical energy store that is formed separately from the storage housing.

The protective device has at least one fastening region by way of which the protective device is to be held, or is held, in particular at least indirectly or directly, on a lower side, pointing downward in the vehicle vertical direction of the motor vehicle in particular in the installed position of the electrical energy store or of the protective device in the motor vehicle, of the storage housing, formed separately from the protective device, of the electrical energy store. In other words, the protective device is able to be fastened, or is fastened, in particular at least indirectly or directly, to the storage housing from below, in terms of the vehicle vertical direction of the motor vehicle, by way of the fastening region. This means that the protective device, in particular in its installed position on the electrical energy store or in the motor vehicle, is disposed, or is able to be disposed, in the vehicle vertical direction under or below the storage housing.

In order to be able in particular to enhance safety in relation to damage or destruction of the electrical energy store, and in order to be able to repair the electrical energy store in a particularly effortless manner, in particular in the event of damage to the electrical energy store, it is provided according to the invention that the protective device has at least one, in particular exactly one, organosheet with at least one rib structure. In other words, the protective device has at least one organosheet which has at least one rib structure. Again in other words, the protective device is at least in regions, in particular largely or completely, formed by the organosheet which has the at least one rib structure. This means, in particular in the installed position of the protective device on the storage housing or in the motor vehicle, that the lower side of the storage housing is able to be covered, or is covered, at least in regions, in particular largely or completely, preferably directly, by the organosheet.

The organosheet can be understood to be in particular a particularly board-shaped construction element which is formed from at least one fiber composite material. The fiber composite material preferably has at least one plastics material that is preferably formed as the matrix of the fiber composite material. Furthermore, the fiber composite material preferably has fibers, for example glass fibers. Thus, the fiber composite material preferably comprises a fibrous woven fabric or a fibrous scrim, wherein the fibrous woven fabric, or the fibrous scrim, is embedded in a plastics material matrix which is thermoplastic, for example.

The rib structure can be understood to mean in particular that the organosheet is formed at least in regions, for example in at least one longitudinal region, in the shape of ribs, meaning that the organosheet has at least one ribbed structure. The rib structure preferably has a plurality, or a multiplicity, of ribs. The ribs are mutually spaced apart at least in regions, for example.

The installed position of the protective device on the storage housing can be understood to mean in particular an installed position of the protective device in which the protective device is held, in particular at least indirectly or directly, on the storage housing by way of the fastening region. T

he invention is based in particular on the following concepts and ideas. A conventional electrical energy store can usually have a base of steel or sheet metal, wherein this base can serve in the vehicle vertical direction downward, or from below, as a conventional protective device for the conventional electrical energy store. In contrast, the protective device according to the invention is an additional protective device for the electrical energy store, which is provided in addition to the storage housing or the base of the storage housing, in particular in order to protect the electrical energy store from below in the vehicle vertical direction. Consequently, in the event of an accident, in the event of an intrusion and/or when the motor vehicle travels over an obstacle, the protective device can be impinged, in particular mechanically, as a result of which the electrical energy store, in particular the storage housing and the storage elements, can be particularly well protected. Consequently, damage to the electrical energy store, in particular to the storage housing, can be minimized in particular. Should the protective device nevertheless be damaged, the protective device can be replaced in a particularly effortless manner, in particular independently of the storage housing. As a result, the electrical energy store can be repaired in a particularly effortless manner, as a result of which repair costs of the electrical energy store, in particular of the motor vehicle, can be particularly minimized, for example. This means that the protective device, for example when the latter has visible damage due to an accident, can be replaced or substituted in order to repair the electrical energy store, and the remainder of the electrical energy store, in particular the storage housing, does not have to be repaired or replaced. Replacement of the protective device can be understood to mean in particular a replacement of the protective device according to invention by a further protective device according to the invention of identical construction, which is formed separately from the protective device according to the invention.

Owing to the fact that the protective device has the organosheet with the rib structure, the best possible protection for the electrical energy store can be enabled in a particularly lightweight manner. The stiffness of the organosheet can in particular be increased by means of the rib structure. The stability and/or acoustics of the protective device, in particular of the electrical energy store, can in particular be improved as a result. Thus, the rib structure has in particular ribs for reinforcing the inherent stiffness of the organosheet. Overall it can be seen that by means of the protective device according to the invention, in particular while maintaining the ground clearance of the motor vehicle, it is possible to achieve improved characteristics in terms of acoustics, in particular aeroacoustics, and/or shock damping of the electrical energy store, in particular of the motor vehicle.

It is particularly preferably provided that the protective device, by way of the fastening region, is reversibly releasable from the storage housing, in particular is able to be fastened, or is fastened, at least indirectly or directly, on the storage housing. This means that the protective device can be disassembled from the storage housing in a nondestructive manner. Thus, the protective device is designed as a protective component which is able to be assembled on the storage housing, and able to be disassembled from the storage housing, in particular in a nondestructive manner.

In a further design embodiment it is provided that the rib structure has at least two ribs that extend obliquely or perpendicularly to one another. In other words, a direction of main extent of at least one first rib of the rib structure runs in a first direction, and a direction of main extent of at least one second rib, in particular different from the first rib, of the rib structure runs in a second direction running obliquely or perpendicularly to the first direction. As a result, the stiffness of the protective device, in particular of the organosheet, can in particular be increased in a particularly lightweight manner. Owing to the particularly high stiffness, the mechanical load bearing capability of the protective device can in particular be increased, and/or an acoustic behavior of the protective device can in particular be improved.

In a further design embodiment it is provided that at least two of the ribs of the rib structure intersect one another. This means that the rib structure has at least two intersecting ribs which are in particular different from one another. In other words, the at least one first rib, in particular at least one of the first ribs, and the at least one second rib of the rib structure, in particular at least one of the second ribs, intersect one another. As a result, the stiffness of the organosheet, in particular of the protective device, can in particular be increased. Intersecting ribs can be understood to mean in particular ribs that cross one another. This means that at least two of the ribs extending obliquely or perpendicularly to one another touch one another, in particular directly.

In a further design embodiment it is provided that the protective device, in particular the organosheet, is designed in the shape of the board. In other words, the protective device, in particular the organosheet, is formed as a board. As a result, the electrical energy store can be particularly well protected against damage in a particularly effortless way. The board can in particular be understood to be a protective board.

In a further design embodiment it is provided that protective device, in particular the organosheet, has at least one main body by means of which, in particular in the installed position of the protective device on the storage housing or in the motor vehicle, the lower side of the storage housing is at least in regions, in particular largely or completely, able to be covered, or is covered, preferably directly. In other words, in the installed position of the protective device on the storage housing, or in the installed position in the electrical energy store, the main body in terms of the vehicle vertical direction extends under or below the storage housing. This means that the storage housing, in particular in terms of the installed position of the protective device in the motor vehicle, is able to be delimited, or is delimited, in particular directly, in the vehicle vertical direction toward the bottom by the main body. This means that the lower side of the storage housing is at least in the regions covered by the main body when the protective device is held on the storage housing by way of the fastening region. As a result, the electrical energy store can be particularly securely protected in the event of a mechanical load impinging the electrical energy store in the vehicle vertical direction from below.

It is preferably provided that the main body has the rib structure. This means that the rib structure is at least partially, in particular largely or completely, formed by the main body.

In a further design embodiment it is provided that the protective device, in particular the organosheet, has at least one covering element which, in particular in terms of the installed position of the protective device in the motor vehicle, adjoins the main body at least indirectly, in particular directly, toward the front in the vehicle longitudinal direction of the motor vehicle. In other words, the covering element is disposed in front of the main body in the vehicle longitudinal direction of the motor vehicle. In particular in the installed position of the protective device on the storage housing or in the motor vehicle, a forward pointing front side of the storage housing in the vehicle longitudinal direction of the motor vehicle is at least partially, in particular largely or completely, preferably directly, able to be covered, or is covered, by means of the covering element. This means that the front side of the storage housing is at least partially able to be covered, or is covered, by the covering element when the protective device is held on the storage housing by way of the fastening region. In other words, in the installed position of the protective device on the storage housing or the electrical energy store, the front side of the storage housing is overlapped toward the front in the vehicle longitudinal direction at least in regions by the covering element. As a result, the electrical energy store, in particular the storage housing, can be particularly securely protected in the event of being mechanically impinged from the front in the vehicle longitudinal direction. It can in particular be reliably avoided that the protective device, in particular the main body, is released from the storage housing due to the mechanical load. In this way, the mechanical load bearing capability of the electrical energy store, in particular of the protective device, can be increased in particular.

Covering element can be understood to be in particular a front region, in terms of the vehicle longitudinal direction, of the protective device, in particular of the organosheet, which at least partially encompasses or comprises the storage housing toward the front in the vehicle longitudinal direction.

It is preferably provided that the main body and the covering element are conjointly formed as an integral design. In other words, the main body and the covering element are formed so as to be mutually integral. This means that the main body and the covering element are formed from one piece, for example from a mono block. Thus, in the case of an integral construction mode, the main body and the covering element are not construction elements which are formed separately from one another and connected to one another. Alternatively, the main body and the covering element can be formed separately from one another.

It is preferably provided that the lower side of the storage housing in terms of the main body and the covering element is able to be covered, or is covered, in particular toward the bottom in the vehicle vertical direction, exclusively by the main body. It is preferably provided that the front side of the storage housing in terms of the main body and the covering element is able to be covered, or is covered, in particular toward the front in the vehicle longitudinal direction, exclusively by the covering element.

In a further design embodiment it is provided that the covering element has at least two walls that extend obliquely or perpendicularly to one another. In other words, the covering element has at least one first wall that extends in a first direction of extent, and the covering element has at least one second wall, in particular different from the first wall, that extends in a second direction of extent extending obliquely or perpendicularly to the first direction of extent. It is preferably provided that the walls in the installed position of the protective device on the storage housing, or in the electrical energy store, in particular in terms of the installed position of the protective device in the motor vehicle, extend at these in regions farther forward in the vehicle longitudinal direction of the motor vehicle than the storage housing. In other words, both walls of the covering element are at least in regions disposed in the vehicle longitudinal direction farther forward than the storage housing, in particular the front side of the storage housing, when the protective device is held on the storage housing by way of the fastening region. Owing to this fact, a particularly reliable protection of the energy store can be effected on the one hand, and a particularly aerodynamically optimized inflow to the protective device can be implemented on the other hand.

The walls are preferably designed to be mutually integral. In other words, the covering element is formed in one piece.

In a further design embodiment it is provided that in the installed position of the protective device on the storage housing, or in the electrical energy store, between one of the walls, in particular the first wall by means of which the front side of the storage housing is at these partially able to be covered, or is covered, in particular directly, and the storage housing there is at least one gap. In other words, one of the walls, in particular the first wall, is spaced apart from the storage housing, in particular in the vehicle longitudinal direction, while forming a void. Downward in the vehicle vertical direction, the gap is delimited, preferably directly, by the other one of the walls, in particular the second wall. Under mechanical load, in particular deformation, on the first wall that delimits, in particular directly, the gap toward the front in the vehicle longitudinal direction, the gap can function so as to dissipate collision energy, i.e. function as a crumple zone. Owing to this fact, damage to the electrical energy store can be particularly reliably avoided. Furthermore, as a result of the gap, the protective device can be assembled on the storage housing in a particularly effortless way. Alternatively or additionally, tolerances can be compensated for or taken into account by the gap, as a result of which the production complexity, in particular the production costs, of the protective device and/or of the storage housing can be in particular minimized. Tolerances can be understood to be in particular manufacturing tolerances of the storage housing and/or of the protective device.

In a further design embodiment it is provided that the organosheet, in particular the main body, has at least one air baffle surface by means of which, in the installed position of the protective device in the motor vehicle when the latter is in motion, inflowing air to the protective device, in particular to the electrical energy store, is able to be directed. In other words, while the motor vehicle is in motion, the air baffle surface is able to be impinged with air. The air can be directed in a targeted manner by the air baffle surface, as a result of which the aerodynamics, in particular drag, of the motor vehicle can in particular be improved. Air can be understood to mean in particular the airstream during travel. Directing the air can in particular be understood to be air flowing about or along the air baffle surface, and/or air being deflected by means of the air baffle surface. The air baffle surface can in particular be referred to as the first air baffle surface.

In a further design embodiment it is provided that the covering element has at least one second air baffle surface, which is in particular different from the first air baffle surface and by means of which, in the installed position of the protective device in the motor vehicle when the latter is in motion, the inflowing air to the protective device, in particular to the covering element, is able to be directed, preferably in a targeted manner, to the first air baffle surface, in particular from the second air baffle surface. In other words, the air flowing onto the second air baffle surface is able to be deflected in a targeted manner by means of the second air baffle surface in order to direct the air from the second air baffle surface to the first air baffle surface. Owing to this fact, flow separation can be avoided or reduced, for example. Alternatively or additionally, negative aeroacoustics effects that may be caused by the airstream can be particularly reliably avoided or reduced.

A second aspect of the invention relates to an arrangement of at least one protective device on a storage housing of an electrical energy store for an electrically drivable motor vehicle. Advantages and advantageous design embodiments of the first aspect of the invention are to be considered advantages and advantageous design embodiments of the second aspect of the invention and vice versa.

The protective device has at least one fastening region by way of which the protective device is held on a lower side, pointing downward in the vehicle vertical direction of the motor vehicle, of the electrical energy store, in particular at least indirectly or directly, on the storage housing, formed separately from the protective device, of the electrical energy store.

In order to in particular be able to increase safety in terms of damage to the electrical energy store, and in order to in particular simplify repairing of the electrical energy store, it is provided according to the invention that the protective device has at least one organosheet with at least one rib structure.

It is preferably provided that the organosheet has at least one external side which, in particular in the installed position of the protective device in the motor vehicle, points downward in the vehicle vertical direction and in particular faces, preferably directly, an environment of the motor vehicle. The external side preferably faces away from the fastening region.

Further features of the invention are derived from the claims, the figures and the description of the figures. The features and combinations of features mentioned above in the description, and the features and combinations of features mentioned hereunder in the description of the figures and/or shown in the figures individually, may be used not only in the respectively mentioned combination but also in other combinations or individually.

The invention will now be explained in more detail by means of preferred exemplary embodiment and with reference to the drawings.

### BRIEF DESCRIPTION OF THE DRAWINGS

FIG. 1 is a schematic perspective view of an arrangement according to an embodiment of the invention;

FIG. 2 is a schematic perspective view of an arrangement according to a further embodiment; and

FIG. 3 is a schematic partial sectional view of the arrangement.

Identical or functionally equivalent elements are provided with the same reference signs in the figures.

### DETAILED DESCRIPTION OF THE DRAWINGS

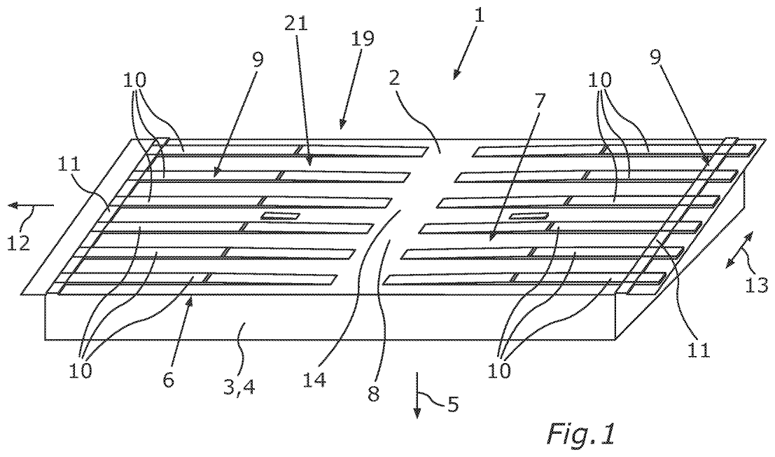

FIG. 1 shows in a schematic perspective view an arrangement 1 of a protective device 2 on a storage housing 3 of an electrical energy store 4 for an electrically drivable motor vehicle. The arrangement 1 in FIG. 1 here is shown in a perspective view from below in terms of a vehicle vertical direction 5 of the motor vehicle. The protective device 2 is designed or provided as protection, in particular mechanical protection, for the electrical energy store 4 of the electrically drivable motor vehicle.

The protective device 2 has at least one fastening region 6 by way of which the protective device 2 is to be held, or is held, in particular at least indirectly or directly, on a lower side 7, pointing downward in the vehicle vertical direction 5 of the motor vehicle, of the storage housing 3, formed separately from the protective device 2. Thus, the protective device 2 is at least largely, in particular completely, disposed on the lower side 7 of the storage housing 3. For example, the protective device 2 is screwed or adhesively bonded to the storage housing 3 by way of the fastening region 6. In particular, when the protective device 2 is screwed to the storage housing 3 by way of fastening region 6, the protective device 2 is able to be released from the storage housing 3 reversibly, or in a nondestructive manner, in a particularly effortless manner.

In order to be in particular able to increase the safety of the electrical energy store 4 in terms of damage, and in order to be able to carry out any repair of the electrical energy store 4 in a particularly effortless manner, it is provided that the protective device 2 has at least one organosheet 8 with at least one rib structure 9. Owing to the rib structure 9, the stiffness of the organosheet 8 can in particular be increased, as a result of which a particularly advantageous acoustic behavior of the protective device 2, in particular of the electrical energy store 4, can be made possible in particular.

The protective device 2, in particular the organosheet 8, and the storage housing 3 are preferably formed from mutually different materials. This means that the protective device 2, in particular the organosheet 8, is formed from a first material, for example, and that the storage housing 3 is formed from a second material, different from the first material, for example. The storage housing 3 is formed, for example, at least partially, in particular largely or completely, from a metallic material.

The organosheet 8 is at least largely, in particular completely, formed from at least one fiber-reinforced, in particular glass fiber-reinforced, plastics material. As a result, the organosheet 8 can be referred to as a glass-fiber organosheet, for example. For example, the organosheet 8 is at least in regions, in particular largely, formed from polyamide, in particular polyamide 6, or from polypropylene. The organosheet 8 is preferably free of metal, in particular free of armor steel.

The rib structure 9 preferably has a plurality of, in particular mutually different, ribs 10, 11. In the exemplary embodiment, the rib structure has a plurality of, for example twelve, first ribs 10 and a plurality of, for example two, second ribs 11. The first ribs 10 run mutually parallel, for example. The second ribs 11 run mutually parallel, for example. As is shown by way of example in FIG. 1, the first and the second ribs 10, 11 extend obliquely or perpendicularly to one another. It is furthermore provided in the exemplary example that at least two of the ribs 10, 11 of the rib structure 9 intersect one another. For example, a first one of the second ribs 11 intersects a plurality, for example six, of the first ribs 10. For example, the second one of the second ribs 11 intersects a plurality, for example six, of the first ribs 10. For example, the first ribs 10 extend at least substantially in the vehicle longitudinal direction 12 of the motor vehicle. For example, the second ribs 11 extend at least substantially in the vehicle transverse direction 13 of the motor vehicle. As is shown in FIG. 1, the ribs 10, 11 extend preferably at least substantially in an in particular imaginary plane defined by the vehicle longitudinal direction 12 and the vehicle transverse direction 13.

It is provided in the exemplary embodiment that the protective device 2, in particular the organosheet 8, is formed in the shape of a board. The organosheet 8 has, for example, a thickness of at least 0.5 mm, in particular at least 1 mm. For example, the thickness of the organosheet 8 is at most 3 mm.

It is preferably provided that the organosheet 8 has at least one, in particular board-shaped, main body 14 by means of which the lower side 7 of the storage housing 3 is at least in regions, in particular largely or completely, able to be covered, or is covered. In the exemplary embodiment shown in FIG. 1 it is provided that the organosheet 8, in particular the main body 14, protrudes beyond the storage housing 3 toward the front and/or toward the rear in the vehicle longitudinal direction 12.

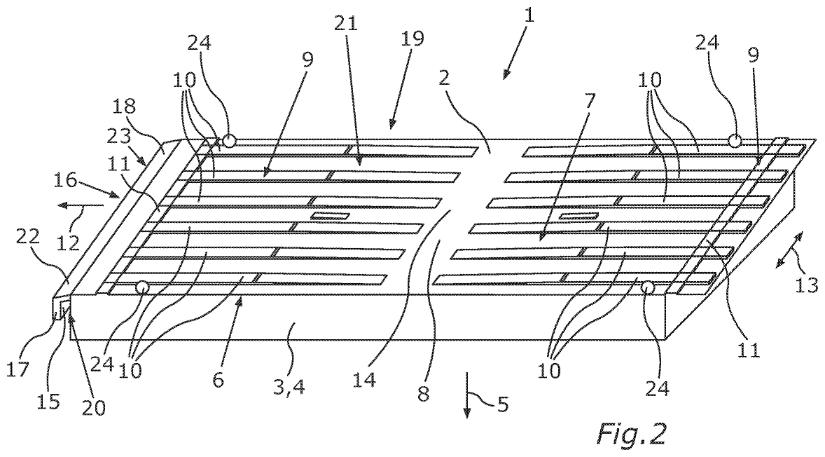

FIG. 2 shows the arrangement 1 in a schematic perspective view, in particular from below, according to a further embodiment in which the protective device 2, in particular the organosheet 8, has at least one covering element 15 which adjoins the main body 14 at least indirectly, in particular directly, toward the front in the vehicle longitudinal direction 12 of the motor vehicle and by means of which a front side 16, pointing toward the front in the vehicle longitudinal direction 12 of the motor vehicle, of the storage housing 3 is at least partially, in particular largely or completely, able to be covered, or is covered.

In the exemplary embodiment shown in FIG. 2, the covering element 15 has at least two walls 17, 18 which extend obliquely or perpendicularly to one another and in the installed position 19 of the protective device 2 on the storage housing 3 extend at least in regions farther toward the front in the vehicle longitudinal direction 12 of the motor vehicle than the storage housing 3. Thus, the covering element 15, in particular the respective wall 17, 18, extends in the direction of travel of the motor vehicle toward the front ahead of the storage housing 3.

For example, provided in the installed position 19 of the protective device 2 on the storage housing 3, between a first one of the walls 17 by means of which the front side 16 of the storage housing 3 is at least partially able to be covered, or is covered, and the storage housing 3, or the front side 16 thereof, is at least one gap 20 which is delimited or formed, in particular directly, in the vehicle vertical direction 5 toward the bottom by the second one of the walls 18. A direction of main extent of the gap 20 runs in the vehicle transverse direction 13 of the motor vehicle, for example.

In a further design embodiment it is provided that the organosheet 8, in particular the main body 14, has at least one first air baffle surface 21 by means of which, in the installed position 19 of the protective device 2 in the motor vehicle when the latter is in motion, inflowing air to the protective device 2, in particular the organosheet 8, is able to be directed, in particular in a targeted manner. For example, the air flowing onto the first air baffle surface 21 is able to be directed by means of the first air baffle surface 21, in particular along an underbody of the motor vehicle, in the direction of a rear of the motor vehicle.

In a further design embodiment it is provided that the covering element, in particular at least one of the walls 17, 18, for example the second wall 18, has at least one second air baffle surface 22 by means of which, in the installed position 19 of the protective device 2 in the motor vehicle when the latter is in motion, the air flowing into the protective device 2, in particular the covering element 15, is able to be directed, in particular in a targeted manner, to the first air baffle surface 21. For example, the walls 17, 18 are connected to one another, in particular directly, by way of at least one edge 23, wherein the edge 23 is preferably designed as an aerodynamic edge which can in particular be referred to as an aero edge.

For example, the walls 17, 18 extend at a mutual angle which is more than 90°. As a result, the air can be directed aerodynamically in a particularly efficient manner to the first air baffle surface 21. The first wall 17 extends at least substantially in the vehicle vertical direction 5, for example. In other words, the first wall 17 has a front side, in particular an end face, pointing toward the front in the vehicle longitudinal direction 12. The second wall 18, in particular the second air baffle surface 22, extends obliquely to the first air baffle surface 21, for example.

For example, the organosheet 8, in particular the main body 14, has a plurality of, for example four, recesses 24 which are in each case provided or designed for the respective jacking point of the motor vehicle. This is visualized in FIG. 2.

The organosheet 8, in particular the protective device 2, is formed integrally, for example. This means that the organosheet 8, in particular the protective device 2, is embodied in an integral construction mode, for example. Alternatively, the organosheet 8, in particular the protective device 2, is designed in multiple pieces or multiple parts, for example. The multi-part embodiment is particularly advantageous when the organosheet 8 has the recesses 24. This enables assembly of the protective device 2 and/or of the jacking point to be particularly simplified. When the organosheet 8 is designed in multiple parts, the organosheet 8 is designed in three parts, for example.

The protective device 2 is at least largely, in particular completely, free of metal, for example.

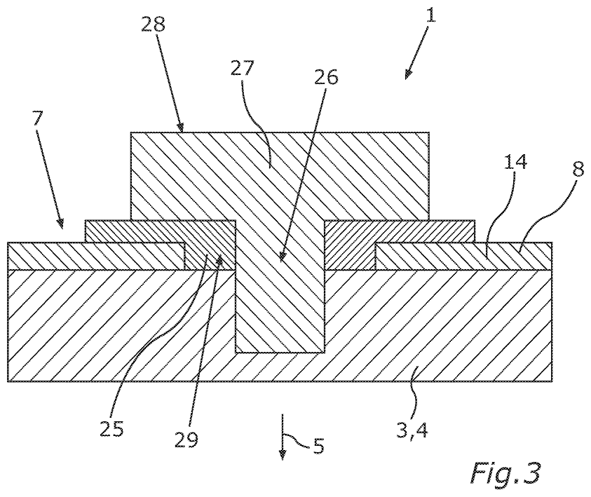

FIG. 3 shows the arrangement 1 in a schematic partial sectional view according to a further embodiment in which the protective device 2 has at least one fastening aid 25 which is formed from metal and can in particular be referred to as a metal insert. The fastening aid 25 is used for screwing the protective device 2, in particular the organosheet 8, to the storage housing 3.

In the exemplary embodiment shown in FIG. 3, the fastening aid 25 has at least one passage opening 26 in which at least one screw element, in particular at least one screw, for screwing the protective device to the storage housing 3, is disposed, or is able to be disposed. The fastening aid 25 is disposed between a screw head 28 of the screw element 27 and the storage housing 3. The fastening aid 25 extends at least in regions within a passage opening 29 of the protective device 2, in particular of the organosheet 8. The protective device 2, in particular the organosheet 8, is able to be fastened, or is fastened, with the intervention of the fastening aid 25, in particular at least indirectly or directly, to the storage housing 3 by means of the screw element 27. The fastening aid 25 is preferably connected to the organosheet 8 in a form-fitting manner. For example, a plurality of the fastening aids 25 are provided, which are in each case mutually spaced apart by 50 to 100 mm, for example.

Numerals such as, for example, “first”, “second”, “third”, etc. are provided in particular only for differentiation and do not indicate any order. This means that the corresponding numerals may be swapped in an arbitrary manner among themselves.

### List of Reference Signs

1 Arrangement
2 Protective device
3 Storage housing
4 Energy store
5 Vehicle vertical direction
6 Fastening region
7 Lower side
8 Organosheet
9 Rib structure
10 First rib
11 Second rib
12 Vehicle longitudinal direction
13 Vehicle transverse direction
14 Main body
15 Covering element
16 Front side
17 First wall
18 Second wall
19 Installed position
20 Gap
21 First air baffle surface
22 Second air baffle surface
23 Edge
24 Recess
25 Fastening aid
26 Passage opening
27 Screw element
28 Screw head
29 Passage opening

1.-10. (canceled)

11. A device for an electrical energy store for an electrically drivable motor vehicle, comprising:
a protective device comprising an organosheet with at least one rib structure; and
at least one fastening region by way of which the protective device is to be held on a lower side, pointing downward in a vehicle vertical direction of the motor vehicle, of a storage housing, formed separately from the protective device, of the electrical energy store.

12. The device according to claim 11, wherein
the rib structure has at least two ribs that extend obliquely or perpendicularly to one another.

13. The device according to claim 12, wherein
at least two of the ribs of the rib structure intersect one another.

14. The device according to claim 11, wherein
the protective device is configured in a board-shape.

15. The device according to claim 11, wherein
the protective device has at least one main body by which the lower side of the storage housing is able to be covered at least in regions; and
at least one covering element which, in a vehicle longitudinal direction of the motor vehicle, adjoins the main body at least indirectly toward a front, and by which a front side of the storage housing that points toward the front in the vehicle longitudinal direction of the motor vehicle is able to be at least partially covered.

16. The device according to claim 15, wherein
the covering element has at least two walls that extend obliquely or perpendicularly to one another and, in an installed position of the protective device on the storage housing, extend at least in regions farther forward in the vehicle longitudinal direction of the motor vehicle than the storage housing.

17. The device according to claim 16, wherein
in the installed position of the protective device on the storage housing, at least one gap is formed between one of the at least two walls and the storage housing, and
the gap is delimited in the vehicle vertical direction toward the bottom by the other one of the at least two walls.

18. The device according to claim 11, wherein
the protective device has at least one air baffle surface by which, in the installed position of the protective device in the motor vehicle, inflowing air to the protective device is able to be directed.

19. The device according to claim 18, further comprising:
at least one covering element which, in a vehicle longitudinal direction of the motor vehicle, adjoins the main body at least indirectly toward a front, and by which a front side of the storage housing that points toward the front in the vehicle longitudinal direction of the motor vehicle is able to be at least partially covered,
wherein the covering element has at least one second air baffle surface by which, in the installed position of the protective device in the motor vehicle, the inflowing air to the protective device is able to be directed to the air baffle surface.

20. An arrangement, comprising:
a storage housing of an electrical energy store for an electrically drivable motor vehicle; and
a protective device on the storage housing, wherein
the protective device has at least one fastening region by way of which the protective device is held on a lower side, pointing downward in a vehicle vertical direction of the motor vehicle, of the storage housing, formed separately from the protective device, and
wherein the protective device comprises an organosheet with at least one rib structure.
